(19) United States
(12) Patent Application Publication
(10) Pub. No.: US 2017/0142996 A1
(43) Pub. Date: May 25, 2017

(54) LAYERED CONFECTIONERY MANUFACTURE

(71) Applicants: Padraig COSTELLO, Eysins (CH); Inderpal KAUR, Eysins (CH); Rachel Tung, Fong CHENG, Roma (IT); Joseph Paul TODMAN, West Midlands (GB); Sarah Kate MINTOFT, Dronfield Derbyshire (GB); Scott RICHARDSON, Sheffield South Yorkshire (GB); Edward LAYFIELD, West Midlands (GB)

(72) Inventors: Padraig COSTELLO, Eysins (CH); Inderpal KAUR, Eysins (CH); Rachel Tung, Fong CHENG, Roma (IT); Joseph Paul TODMAN, West Midlands (GB); Sarah Kate MINTOFT, Dronfield Derbyshire (GB); Scott RICHARDSON, Sheffield South Yorkshire (GB); Edward LAYFIELD, West Midlands (GB)

(73) Assignee: CADBURY UK LIMITED, Birmingham West Midlands (GB)

(21) Appl. No.: 13/698,059

(22) PCT Filed: May 23, 2011
(86) PCT No.: PCT/GB2011/050970

§ 371 Date: Apr. 3, 2013

(30) Foreign Application Priority Data
May 27, 2010 (GB) 1008870.6

(51) Int. Cl. A23G 3/34; A23G 3/54; A23G 1/54

(52) U.S. Cl. CPC A23G 3/0065; A23G 1/54; A23G 3/54

(57) ABSTRACT

A process for the manufacture of a layered confectionery product having discrete jelly and fat-containing confectionery components, comprising introducing a first of the components to a support, in molten or substantially-molten form, applying the second component, in non-solid form, to an exposed and non-solidified surface of the first, and allowing or effecting cooling of the first and second components such that they bond to each other as discrete confectionery layers.

### BACKGROUND AND TECHNICAL FIELD OF THE INVENTION

This invention relates, in broad terms, to a process for the manufacture of a layered confectionery product, and relates, more particularly, to the manufacture of a confectionery product having discrete jelly and fat-containing components.

The manufacture of jelly confectionery products, and fat-containing confectionery products (such as chocolate) are, of course, well known in their own right, with each involving a number of different steps, quite distinct from each other, and a range of differing process parameters, given the very different compositions of the two types of confectionery.

In outline terms, jelly confectionery is typically prepared by cooking the main ingredients (including a bulk sweetener such as sugar, glucose or suitable substitute and a gelling system (including pectin, gelatine and other gelling compositions which will be apparent to the skilled addressee)) to provide the required physical properties. This cooking takes place at a suitable temperature, with the resulting hot fluid then being deposited into a mold, for subsequent cooling and release. Chocolate, on the other hand, by virtue of its natural (cocoa bean) origin, is manufactured very differently, with the process involving both cocoa solids and cocoa butter, in combination with cocoa liquor (resulting from processing of the beans themselves), with various types of chocolate stemming from different proportions of cocoa (solids and butter) and a number of post-mixing processes.

Whilst jelly confectionery can sometimes contain a small amount of oils, to impart flavors and physical properties, such confectionery is substantially devoid of any fat, with the term “fat-containing confectionery” thus being used, in the industry, and herein, to refer to products having a more significant fat content, such as chocolate. As the term “fat-containing” is well known in the relevant art, and as the amount of fat varies widely, with differing chocolate blends, it will be appreciated that the term is used herein to describe a range of confectionery products which includes chocolate or chocolate flavored products, but which is intended to exclude jelly-based confectionery types.

### Overview of the Prior Art

As indicated above, specific manufacturing processes for both jelly and fat-containing confectionery products are widely known, although attempts to combine the two, to produce confectionery products which include both jelly and fat-containing components, have been less prevalent and have met with variable commercial success. Whilst layered jelly/fat-containing confectionery products are known in themselves (see U.S. Pat. No. 6,203,831—Nestec S. A.), the prior art does not address the issue of adherence of the two layers, to each other, which is an important factor where the manufacture of discrete (e.g. bite-sized) confectionery products is at issue. GB2126070 (Crown Confectionery Co. Ltd.) discloses a method for manufacturing a jelly confectionery product which is coated with chocolate, and JP6141777 (Kanebo Limited) discloses a composite confectionery product having chocolate and jelly components, with the chocolate seemingly being attached to a jelly substrate by filling a hole with a plug of chocolate.

GB2402648 (Dunlop) discloses a method of forming a layered confectionery product by urging a solid “slab” of jelly/chocolate into contact with a liquid mass of jelly/chocolate in a mold, with the liquid then being cooled, resulting in a two-tone product. The bond between the jelly and chocolate has proven to be very weak.

It would be preferable to prepare a chocolate/jelly confectionery product where the two layers of material have improved adhesion.

### SUMMARY OF THE INVENTION

According to a first aspect of the present invention, there is provided a process for the manufacture of a layered confectionery product having discrete jelly and fat-containing confectionery components, comprising introducing a first of the components to a support, in molten or substantially-molten form, applying the second component, in non-solid form, to an exposed and non-solidified surface of the first, and allowing or effecting cooling of the first and second components such that they bond to each other as discrete confectionery layers.

The term non-solid and/or non-solidified is intended to mean that the component does not have a readiness to flow, which is in contrast to the properties of a molten or substantially molten form.

The first and second components may be the jelly and fat-containing confectionery components, respectively.

The first component may be introduced in substantially liquid form. After a cooling interval during which partial solidification of some of the first component occurs, to avoid or reduce any substantial mixing of the two components, the second component in substantially liquid form may then be applied to the exposed surface of the first.

The cooling interval may be between five seconds and one minute, preferably between ten and fifty seconds and more preferably between twenty and forty seconds.

The fat-containing component may be chocolate-based, and the chocolate-based component may be milk or dark chocolate, or a white chocolate being substantially free from cocoa solids.

The first component may be a jelly confectionery component and the second component may be a white chocolate component, with the process further comprising applying, to an exposed surface of the second component, a third (milk or dark chocolate) component such that the white chocolate component insulates the milk/dark chocolate from the heat of the jelly component, prior to cooling.

The third component may form a layer which is thicker than that of the second component, with the third component layer conveniently having a thickness of about five millimeters, and the second component layer conveniently having a thickness of about one millimeter.

The support may be a mold cavity and at least the first component may be molded using a starch-molding process. Alternatively, the support may be a plastics or silicone mold cavity which is provided with a dusting or film of a release material (such as starch). As a further alternative, the support may be a moveable platform such as a belt (which may be coated with a release material such as starch) with the mold/release starch preferably having a moisture content of between 5% and 8%.

The first and second components may subsequently be coated, at least partially, by an outer confection layer.

The outer confection layer may be a chocolate layer, with the coating being effected by a panning, enrobing or immersion process.

The term ‘chocolate’ in the context of the present invention is not restricted by the various definitions of chocolate provided by government and regulatory bodies. A chocolate shell material is simply a product that contains a fat phase and which is obtained from cocoa products and sweeteners.

The chocolate material comprises at least one fat. The fat may be cocoa butter, butterfat, a cocoa butter equivalent (CBE), a cocoa butter substitute (CBS), a vegetable fat that is liquid at standard ambient temperature and pressure (SATP, 25° C. and 100 kPa) or any combination of the above. In a particular embodiment, the chocolate material comprises cocoa butter.

CBEs are defined in Directive 2000/36/EC. Suitable CBEs include illipe, Borneo tallow, tengkawang, palm oil, sal, shea, kokum gurgi and mango kernel. CBE's are usually used in combination with cocoa butter. In one embodiment, the chocolate material comprises no more than 5wt % CBE's.

The chocolate material may comprise a cocoa butter substitute (CBS) (sometimes known as a cocoa butter replacer, CBR) in place of some or all of the cocoa butter. Such chocolate materials are sometimes known as compound chocolate. Suitable CBS's include CBS laurics and CBS non-laurics. CBS laurics are short-chain fatty acid glycerides. Their physical properties vary but they all have triglyceride configurations that make them compatible with cocoa butter. Suitable CBS's include those based on palm kernel oil and coconut oil. CBS non-laurics consist of fractions obtained from hydrogenated oils. The oils are selectively hydrogenated with the formation of trans acids, which increases the solid phase of the fat. Suitable sources for CBS nonlaurics include soya, cottonseed, peanut, rapeseed and corn (maize) oil.

The chocolate material may comprise at least one vegetable fat that is liquid at standard ambient temperature and pressure (SATP, 25° C. and 100 kPa).

Suitable vegetable fats include corn oil, cotton seed oil, rapeseed oil, palm oil, safflower oil, and sunflower oil.

The present invention is further applicable to chocolate materials in which some or all of the fat is constituted by a partly or wholly non-metabolisable fat, for example Caprenin.

In accordance with a second aspect of the present invention, there is provided a layered confectionery product having discrete jelly and chocolate components, made in accordance with the process described above.

In accordance with a third aspect of the present invention, there is provided a bar, bite-sized or treat-sized confectionery product having a chocolate base layer and a jelly upper layer which is bonded to the base layer, with the jelly having a molded outer surface which is visible to the consumer.

The jelly layer may be substantially uncoated, other than by way of any residual molding release agent.

In accordance with a fourth aspect of the present invention, there is provided a method of reducing or controlling heat-induced discoloration of a milk/dark chocolate layer of a layered jelly/chocolate molded confectionery product, comprising introducing, during the molding process, a white chocolate layer between the jelly and milk/dark chocolate layers, to insulate the milk/dark chocolate layer from the heat of the non-solidified jelly layer.

In accordance with a fifth aspect of the present invention, there is provided a confectionery product having discrete jelly and fat-containing confectionery layers, bonded to each other by an intermediate later resulting from heat-induced adherence of the jelly and fat-containing layers.

The intermediate layer may result from heat-induced mixing of parts of the jelly and fat-containing layers.

The intermediate layer may result from heat-induced penetration of the fat-containing layer into the jelly layer, or vice versa.

The fat-containing layer may be a chocolate layer and the ratio, by volume, of jelly to chocolate, may be about one to two.

### BRIEF DESCRIPTION OF THE DRAWINGS

The present invention, in its various aspects, will now be described in greater detail, but strictly by way of example only, by reference to the following drawings, which show non-limiting and specific embodiments:

FIG. 1 illustrates a first stage in a manufacturing process, involving a mold and dual nozzle dispenser;

FIG. 2 illustrates a second stage of the process, following that shown in FIG. 1;

FIG. 3 shows a third stage in which jelly and chocolate have been introduced to the mold;

FIG. 4 shows a perspective view of a resulting layered confectionery product, having been released from the mold of FIGS. 1 to 3;

FIG. 5 is a side view of a three-layer confectionery product, in which the jelly and milk/dark chocolate layers are separated by a white chocolate layer;

FIG. 6 shows the first step in a different embodiment of manufacturing process, involving a starched belt;

FIG. 7 shows a second stage of the process embodiment of FIG. 6, in which a quantity of molten/substantially-molten jelly has been applied to the belt;

FIG. 8 shows a dual-layer confectionery product on the belt, resulting from the application of non-solid chocolate to the jelly substrate;

FIG. 9 is a side/cutaway view of a filled mold (as per FIGS. 1 to 3), in which the second (chocolate) layer has been introduced in a more solid form, so as to deform the upper layer of the molten/substantially-molten jelly; and

FIG. 10 shows an embodiment of a molded product, in “bar” form.

### DETAILED DESCRIPTION OF THE INVENTION

The present invention offers many benefits over the prior art as it relates to novel multi-layered jelly/chocolate confectionery products, and their novel manufacturing method, with the products exhibiting relatively strong inter-layer adherence and having a highly attractive, and striking, visual appearance. Notably, in the “key” embodiment of the invention, each layer of the layered composite is visible to a consumer, prior to initial consumption, allowing a variety of shapes, colors and finishes to be imparted to the confectionery product. In hand with that, the dual (jelly/chocolate) nature of the product provides appealing and unusual taste/textural “mouth feel” characteristics, and allows (for example) the “fun” of the well known “Jelly Babies” confectionery to be combined with the luxurious and enduring appeal of a chocolate product.

Hitherto, it has not proved possible to manufacture, to a sufficient degree of quality, and on a commercial scale, a jelly/chocolate layered confectionery product in which the bonding interface between the jelly and chocolate has sufficient strength so as not to break too easily, during transit, packing and the like. The present invention, in its various aspects, addresses this by carefully controlling the temperature (and hence state) of the jelly and chocolate components, as they are introduced to a support (such as a mold), in the early stages of the manufacturing process.

The precise composition of the jelly and chocolate layers is not critical to the performance of the invention, although it is important, for commercial and “mouth feel” reasons, to provide a jelly texture which complements the texture of the chocolate layer. In that light, and to achieve a “soft melt in the mouth” texture, the following recipe was employed:

| Ingredients | Proportion |
|---|---|
| Glucose (high DE [dextrose equivalency[ | 55-65% |
| for viscosity and short soft final texture. | |
| Sugar | 30% |
| Gelatine (high Bloom for clarity) | 4%-6% |
| Malic acid (to provide gentle/long lasting | As required |
| acidity)/natural flavors/colors. | |

As regards the chocolate composition, the examples below include the use of both milk and white chocolate (white chocolate differing principally in that it lacks any cocoa solids), with generally standard chocolate formulations being employed, but with a slight increase (of 2.5%) in the amount of cocoa butter used, to reduce the viscosity and thus to eliminate/mitigate the effects of tailing, and so that the chocolate will “self level” after deposition. In order to mix the additional cocoa butter component, the chocolate blends were heated to 40° C., subsequently tempered (controlled cooling and agitation to ensure correct crystallisation of the cocoa butter and thus an acceptable finish and feel), prior to deposition (see below) at 30° C.

The preferred manner to impart shape to the confectionery product is the process of molding, involving mold trays (having mold cavities which contain formations corresponding to the desired outward appearance of a finished product) which are dusted with a thin layer of molding starch, with the molding starch having a moisture content of between 5% and 8%. Above that range, poor molding can result, with the attraction of foreign matter to the confectionery surface, whereas starch which is too dry can result in undesirable hardening or crusting, on the outer surface. In summary (noting that the starch molding process is well known, in its own right), the process involves the application of molten/substantially-molten product into the starched mold, allowing the product to cool, and then tilting/overturning the mold tray (itself housing a number of mold cavities) to release the cooled (and at least partially solidified) product from the mold. The use of molding in this particular process, however, offers a further advantage in that the resulting chocolate surface has a matt appearance, which is beneficial for unwrapped (e.g. bite-sized) products, where scuffing/in-package abrasion and agitation can be a concern.

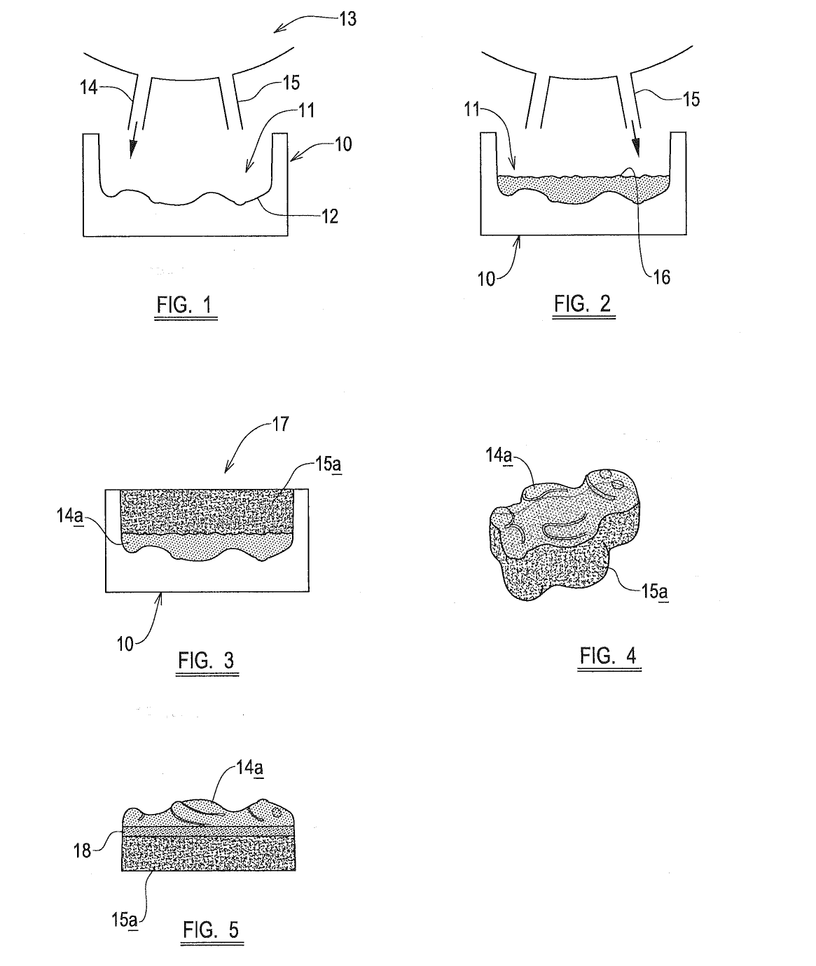

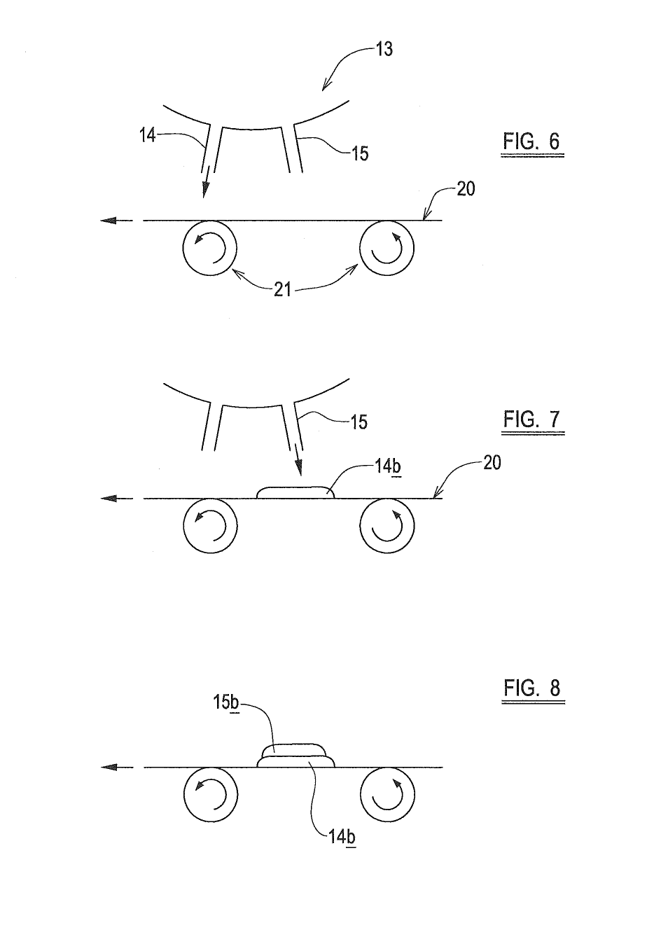

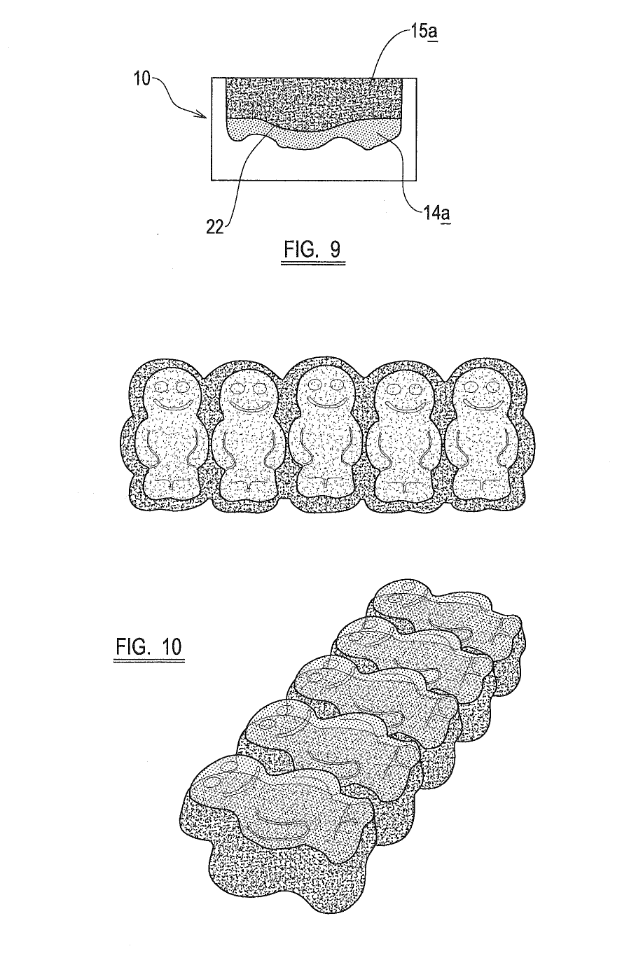

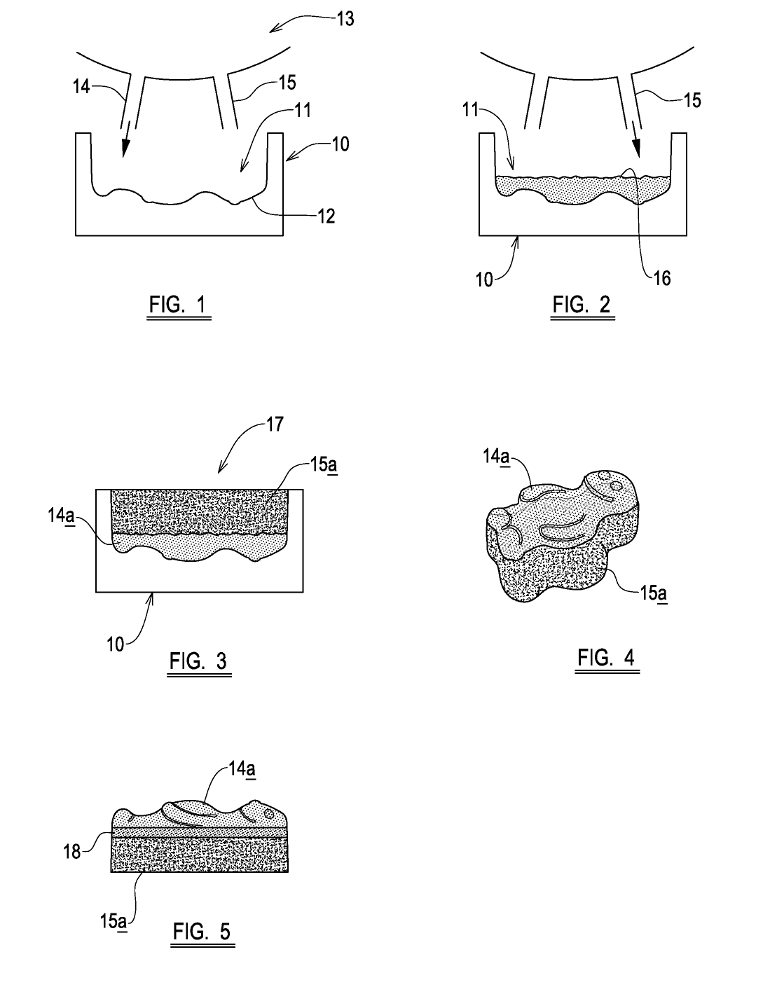

Referring first to FIGS. 1 to 5, illustrating the manufacture of a starch molded layered confectionery product, a mold 10 having a cavity 11 is shown, with the cavity having a shaped surface 12 which is configured so as to impart an outward “Jelly Baby” appearance to a finished product. The mold 10 is one of several, contained within a molding tray (not shown) and each inner surface 12 is dusted with a fine layer (in conventional manner) of molding starch, of the type described generally above. A liquor dispenser, shown schematically at 13, has two nozzles 14 and 15 (although the two nozzles may be in a concentric arrangement similar to that employed in one-shot depositors), each connected to separate (not shown) holding tanks, containing, respectively, molten jelly liquor and molten chocolate, for sequential dispensing to the mold cavity 11. FIG. 1 illustrates, in schematic form, the introduction of a quantity of molten jelly to the cavity 11, resulting (see FIG. 2) in a partially-filled mold 10, having an upper layer 16 of non-solidified jelly exposed to the second nozzle 15. Molten milk chocolate is then dispensed, through nozzle 15, into the mold cavity 11, bringing the molten chocolate into contact with the (as yet unsolidified) jelly mass, resulting in the layered product shown generally at 17, in FIG. 3. The jelly and chocolate layers (14a and 15a) do not mix to any complete extent, but the non-solid state of each component, as they are brought together, appears to result in a degree of mixing/interpenetration of the layers, at the interface between them. The degree of mixing can be influenced by controlling the temperature of each component, and by the time delay between the jelly and subsequent chocolate deposits. Experimentation has found that a delay of between five seconds and one minute is suitable, as this allows the jelly layer to start to solidify, very slightly, to an extent which prevents true mixing of both layers, as the chocolate is deposited, but which also allows a degree of interpenetration to occur, near the interface. Subsequent to the chocolate layer being deposited, the combined product is allowed to cool to 20° C., with the layered product then being removed from the mold by a tilting or inversion process (in generally known manner), and a subsequent (also known) de-starching operation [employing, for example, a “Winkler” flat bed de-starcher] and a glazing operation, prior to packing. The finished product, shown in FIG. 4, has a chocolate base layer 15a and an upper (in use) jelly layer 14a, which has a shiny, glazed and thus highly-visually appealing appearance, allowing partial transmission of the chocolate color, below it.

FIG. 5 illustrates, in schematic form, a slight modification to the process and product of FIGS. 1 to 4, in which an intermediate layer 18, of white (free of cocoa solids) chocolate is employed. In order to arrive at the three-layer product of FIG. 5, the initial jelly deposition stage is unchanged, but the subsequent step involves the deposition of a relatively small amount of white chocolate, in place of the milk chocolate deposit, described above. The timings and temperatures are largely as detailed above, with application of the white chocolate layer being followed, again by a suitable time interval, by the application of a somewhat thicker layer of milk (or indeed dark) chocolate. This results in a three layer construction, and has unexpected (and significant) technical advantages, related to the temperatures employed and the cooling profile of the jelly layer. Specifically, given the relatively high temperatures involved in the handling of molten jelly, the subsequent application of a chocolate layer can result in detempering of that chocolate component, giving rise—in the case of milk or dark chocolate—to an unsightly appearance of the layer in contact with the hot jelly. The use of a white chocolate component, as an intermediate layer, addresses this, as any detempering of a white chocolate component does not result in any visible discoloration, meaning that the insulated milk/dark chocolate layer (applied last but forming the base layer, in the resulting product) is not affected in this way. The relative thicknesses of the white and milk/dark chocolate layers can of course be varied, as required, although it has been found that a one millimeter thickness of white chocolate, and a five millimeter thickness for the milk/dark layer is especially suitable.

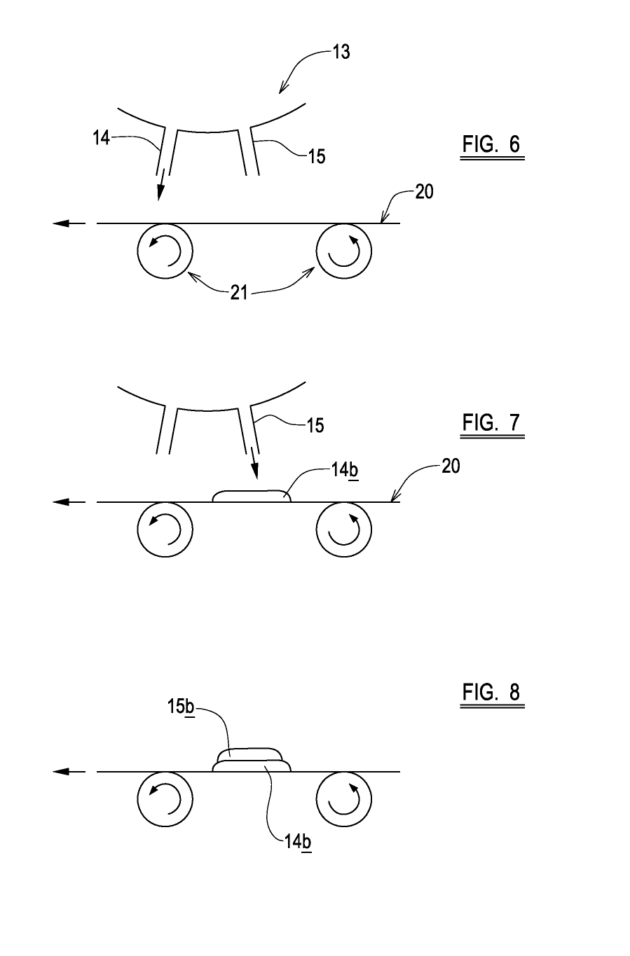

Referring now to FIGS. 6 to 9, there is shown an alternative process for the manufacture of a layered jelly/chocolate confectionery product, involving a moving starched belt 20, driven (in these examples) by a pair of wheels 21. Starched belts are known, in themselves, and thus it is not necessary to elaborate on those here. The belt 20, in these examples, moves from right to left (as shown by the arrow, on the left hand side of the belt), with the liquor dispenser 13 being disposed above the moving surface, such that molten jelly and chocolate can be dispensed, respectively, through nozzles 14 and 15, onto the belt below.

FIG. 7 shows a quantity of deposited jelly 14b in position on the belt, having been deposited upstream (i.e. to the right of FIG. 7) in readiness for a subsequent deposit of chocolate (through nozzle 15) onto it. The considerations (time and temperature) explained in relation to FIGS. 1 to 5 apply equally, here, in that it is necessary to ensure that a degree of mixing/penetration can occur, between the jelly and chocolate layers 14b/15b, so as to effect a satisfactory bond, upon cooling, between them. The effect of the belt process, of course, is to produce a relatively flat dual-layer configuration, in contrast to the molded product of FIGS. 1 to 5, but having largely similar color, texture and “mouth feel” characteristics.

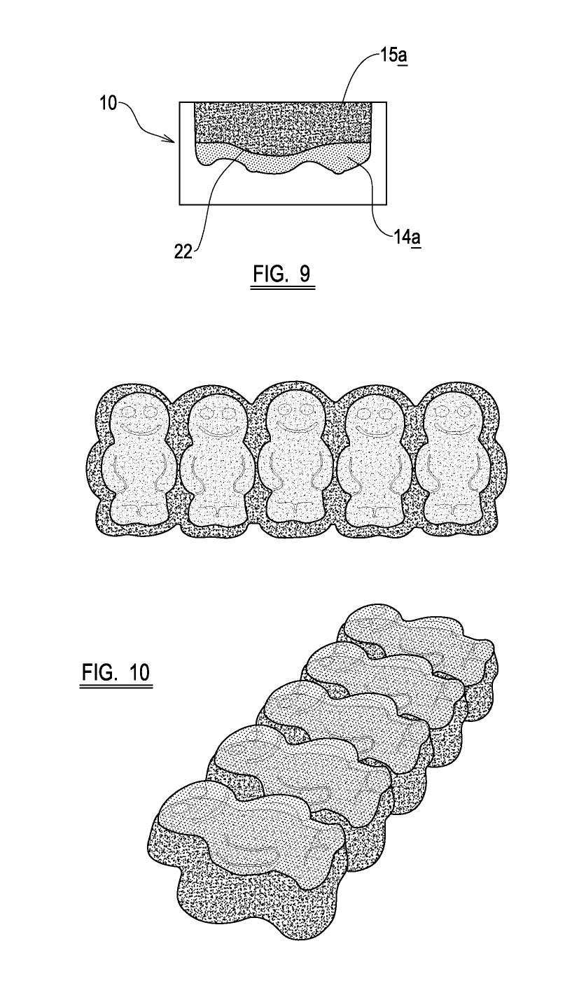

Depending upon the state (i.e. degree of fluidity) of the chocolate, as it is applied to the warm, soft jelly layer below it, the interface between the two can either be generally flat (as shown in FIG. 8) or curved/shaped, as shown, for example, in FIG. 9. Whilst there are a number of potential ways to achieve the configuration of the product shown in FIG. 9, one manner is to “press” a near-solidified chocolate component, having a convex lower surface 22, into contact with the non-solidified upper surface of the jelly layer, with the heat of the jelly layer causing the exposed chocolate surface to melt, to some degree, allowing mixing/interpenetration of the two, whilst retaining the basic convex shape of the chocolate component.

Turing lastly to FIG. 10, this shows (in both perspective and plan views) a jelly/chocolate layered confectionery product in “bar” form, produced by sequential depositions of jelly into a suitably configured (multiple) mold, followed by the application of a larger quantity of chocolate, substantially in the manner described by reference to FIGS. 1 to 5. It will be appreciated, of course, that different colored jellies could be employed, on a given bar, and that the chocolate layer could be a dual layer, as described in relation to FIG. 5.

It will also be appreciated that the finished product, whether it be produced by a molding or belt process, could subsequently be coated, panned or enrobed with a further chocolate layer, in a generally conventional manner.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A process for the manufacture of a layered confectionery product having discrete jelly and fat-containing confectionery components, comprising introducing a first of the components to a support, in molten or substantially-molten form, applying the second component, in non-solid form, to an exposed and non-solidified surface of the first, and allowing or effecting cooling of the first and second components such that they bond to each other as discrete confectionery layers.

2. A process according to claim 1 wherein the first and second components are the jelly and fat-containing confectionery components, respectively.

3. A process according to claim 1 wherein the first component is introduced in substantially liquid form and wherein the second component is applied to the exposed surface of the first, also in substantially liquid form, after a cooling interval during which partial solidification of some of the first component occurs, to avoid or reduce any substantial mixing of the two components.

4. A process according to claim 3 wherein the cooling interval is between 5 seconds and 1 minute.

5. A process according to claim 1 wherein the fat-containing component is chocolate-based.

6. A process according to claim 5 wherein the chocolate-based component is milk or dark chocolate, or a white chocolate being substantially free from cocoa solids.

7. A process according to claim 5 wherein the first component is a jelly confectionery component and the second component is a white chocolate component, the process further comprising applying, to an exposed surface of the second component, a third (milk or dark chocolate) component such that the white chocolate component insulates the milk/dark chocolate from the heat of the jelly component, prior to cooling.

8. A process according to claim 7 wherein the third component forms a layer which is thicker than that of the second component.

9. A process according to claim 7 wherein the layer of the third component has a thickness of about 5 mm and the layer of the second component has a thickness of about 1 mm.

10. A process according to claim 1 wherein the support is a mold cavity and at least the first component is molded using a molding process.

11. A process according to claim 10 wherein the molding starch has a moisture content of between 5% and 8%.

12. A process according to claim 1 wherein the first and second components are subsequently coated, at least partially, by an outer confection layer.

13. A process according to claim 12 wherein the outer confection layer is a chocolate layer and wherein the coating is effected by a panning, enrobing or immersion process.

14. A layered confectionery product having discrete jelly and chocolate components, made in accordance with claim 1.

15. A bar, bite-sized or treat-sized confectionery product having a chocolate base layer and a jelly upper layer which is bonded to the base layer, with the jelly having a molded outer surface which is visible to the consumer.

16. A confectionery product according to claim 15 wherein the jelly layer is substantially uncoated, other than by way of any residual molding release agent.

17. A method of reducing or controlling heat-induced discoloration of a milk/dark chocolate layer of a layered jelly/chocolate molded confectionery product, comprising introducing, during the molding process, a white chocolate layer between the jelly and milk/dark chocolate layers, to insulate the milk/dark chocolate layer from the heat of the non-solidified jelly layer.

18. A confectionery product having discrete jelly and fat-containing confectionery layers, bonded to each other by an intermediate layer resulting from heat-induced adherence of the jelly and fat-containing layers.

19. A confectionery product according to claim 18 wherein the intermediate layer results from heat-induced mixing of parts of the jelly and fat-containing layers.

20. A confectionery product according to claim 18 wherein the intermediate layer results from heat-induced penetration of the fat-containing layer into the jelly layer, or vice-versa.

21. A confectionery product according to claim 18 wherein the fat-containing layer is a chocolate layer and wherein the ratio, by volume, of jelly to chocolate, is about 1:2.
